(19) United States
(12) Patent Application Publication
(10) Pub. No.: US 2026/0062595 A1
(43) Pub. Date: Mar. 5, 2026

(54) CONDUCTIVE DIE ATTACH COMPOSITIONS

(71) Applicant: Henkel AG & Co. KGaA, Duesseldorf (DE)

(72) Inventors: Lina Bian, Irvine, CA (US); Xuan Hong, Irvine, CA (US); Bin Wei, Irvine, CA (US); Selene Guadalupe Hernandez, Irvine, CA (US)

(21) Appl. No.: 19/379,157

(22) Filed: Nov. 4, 2025

Related U.S. Application Data
(63) Continuation of application No. PCT/US2024/028044, filed on May 6, 2024.
(60) Provisional application No. 63/463,923, filed on May 4, 2023.

(51) Int. Cl. C09J 9/02; C09J 4/06; C09J 11/04; C09J 133/14; C09J 163/00; H01L 23/00

(52) U.S. Cl. CPC C09J 9/02; C09J 4/06; C09J 11/04; C09J 133/14; C09J 163/00

(57) ABSTRACT

Provided herein is a conductive die attach composition comprising:
A resin comprising those containing one or more maleimide, itaconimide or nadimide functional groups or combinations of said functional groups;
An epoxy component;
A (meth)acrylate component;
An aromatic anhydride; and
A conductive filler.

### BACKGROUND

### Field

Provided herein is a conductive die attach composition comprising:
(a) A resin comprising those containing one or more maleimide, itaconimide or nadimide functional groups or combinations of said functional groups;
(b) An epoxy component;
(c) A (meth)acrylate component;
(d) An aromatic anhydride; and
(e) A conductive filler.

### BRIEF DESCRIPTION OF RELATED TECHNOLOGY

Package reliability is one of the most troublesome factors that concern designers and manufacturers of semiconductor devices. One reason for this is the copper, nickel, and nickel alloys that are widely used in leadframe material in the industry today suffer from adhesion inconsistency particularly under harsh environmental conditions.

These metals and metal alloys are used in leadframe construction due to their high coefficient of thermal expansion (“CTE”), high thermal dissipation and high thermal conductivity. But because of the adhesion inconsistency noted above, improvements in adhesion for die attach pastes on copper, nickel and nickel alloy leadframes has been a long felt yet unmet desire. Performance consistency of die attach materials in this regard has been elusive to date despite the efforts made to overcome the deficiencies of existing die attach materials. Until now.

### SUMMARY

Provided herein is a conductive die attach composition comprising:

A resin comprising those containing one or more maleimide, itaconimide or nadimide functional groups or combinations of said functional groups;
An epoxy component;
A (meth)acrylate component;
An aromatic anhydride; and
A conductive filler.

The conductive die attach composition demonstrates when cured through exposure to elevated temperature conditions and after exposure to further elevated temperature conditions of about 85° C. to about 125° C., such as about 121° C., and elevated humidity conditions of about 85% to about 100% for a period of time of about 16 hours, a die shear strength on copper lead frame of greater than about 200% when compared with a comparable composition without the aromatic anhydride. Put another way, in short after exposure to such conditions the bonding force between substrate and die attach paste is harder to break. In addition, the conductive die attach composition assists in improved solder reflow.

### DETAILED DESCRIPTION

As noted above, provided herein is a conductive die attach composition comprising:

A resin comprising those containing one or more maleimide, itaconimide or nadimide functional groups or combinations of said functional groups;
An epoxy component;
A (meth)acrylate component;
An aromatic anhydride; and
A conductive filler.

### Resin

The resin of (a) used in the inventive conductive die attach composition may be selected from one or more of

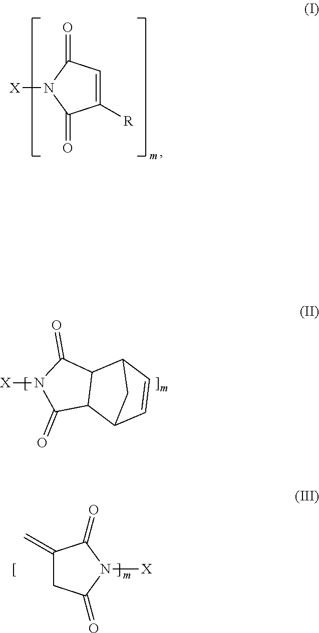

wherein

$$m = 1 - 15 ,$$

R is independently selected from hydrogen or alkyl having from 1 to about 4 carbon atoms, and
X is a monovalent moiety or a multivalent linking moiety comprising organic or organosiloxane radicals.

For instance, more specific representations of the maleimides, itaconimides and nadimides include those corresponding to structures I, II and III, where

$$m = 1 - 6 ,$$

R is independently selected from hydrogen or lower alkyl, and
X comprises a monovalent moiety or a multivalent linking moiety selected from straight or branched chain alkyl, alkylene, oxyalkyl, oxyalkylene, alkenyl, alkenylene, oxyalkenyl, oxyalkenylene, ester, reverse ester, polyester, amide, reverse amide, or polyamide, optionally interrupted or substituted by one or more heteroatoms, such as oxygen, nitrogen and/or sulfur, and optionally functionalized with substituents selected from hydroxy, alkoxy, carboxy, nitrile, cycloalkyl or cycloalkenyl, where the number of carbon atoms in the linking moeity falls between about 12 to about 500.

In a particularly desirable aspect of the invention, the maleimide, itaconimide and/or nadimide functional group of the maleimide, itaconimide and/or nadimide compound, respectively, is attached to a monovalent radical or the maleimide, itaconimide and/or nadimide functional groups of the maleimide, itaconimide and/or nadimide compound are separated by a polyvalent radical, each of the monovalent radical or the polyvalent radical having sufficient length and branching to render the maleimide and/or nadimide compound a liquid.

In a more specific recitation of such maleimide, itaconimide and nadimide of structures I, II and III, each R is independently hydrogen or alkyl having one to about four carbon atoms, —X— comprises a branched chain alkyl, alkylene or alkylene oxide species having sufficient length and branching to render the maleimide, itaconimide or nadimide compound a liquid, and m is 1, 2 or 3.

Desirably, the resin of (a) may be phenylene dimaleimide (available commercially for example from Arkema Inc. under the trade designation SR-525A, which is supplied with a particle size of less than 10 μm according to the manufacturer).

The resin of (a) may be present in an amount of about 1 percent by weight to about 10 percent by weight, such as about 1 percent by weight to about 3 percent by weight, based on the total weight of the composition.

### Epoxy Component

The epoxy component of (b) used in the inventive conductive die attach composition may be selected from an aromatic epoxy resin, an aliphatic epoxy resin and a cycloaliphatic epoxy resin. Of course, combinations of these epoxy resins may also be used.

More specifically, for an aromatic epoxy resin the epoxy component of (b) may be selected from biphenyl epoxy resin, bisphenol A, E, S or F epoxy resin, and combinations thereof.

For the aliphatic epoxy resin, the epoxy component may include the mono-functional epoxy compounds: C₄-C₂₈ alkyl glycidyl ethers; C₂-C₂₈ alkyl- and alkenyl-glycidyl esters, and C₁-C₂₈ alkyl- and mono-phenol glycidyl ethers; as well as the multifunctional epoxy compounds polyglycidyl ethers of pyrocatechol, resorcinol, hydroquinone, 4,4′-dihydroxydiphenyl methane (or bisphenol F, such as RE-303-S or RE-404-S available commercially from Nippon Kayuku, Japan), 4,4′-dihydroxy-3,3-dimethyldiphenyl methane, 4,4′-dihydroxydiphenyl dimethyl methane (or bisphenol A), 4,4′-dihydroxydiphenyl methyl methane, 4,4′-dihydroxydiphenyl cyclohexane, 4,4-dihydroxy-3,3′-dimethyldiphenyl propane, 4,4′-dihydroxydiphenyl sulfone, and tris(4-hydroxyphenyl) methane; polyglycidyl ethers of transition metal complexes; chlorination and bromination products of the above-mentioned diphenols; polyglycidyl ethers of novolacs; polyglycidyl ethers of diphenols obtained by esterifying ethers of diphenols obtained by esterifying salts of an aromatic hydrocarboxylic acid with a dihaloalkane or dihalogen dialkyl ether; polyglycidyl ethers of polyphenols obtained by condensing phenols and long-chain halogen paraffins containing at least two halogen atoms; N,N′-diglycidyl-aniline; N,N′-dimethyl-N, N′-diglycidyl-4,4′-diaminodiphenyl methane; N,N,N′,N′-tetraglycidyl-4,4-diaminodiphenyl methane; N,N′-diglycidyl-4-aminophenyl glycidyl ether; N,N,N′,N′-tetraglycidyl-1,3-propylene bis-4-aminobenzoate; phenol novolac epoxy resin; cresol novolac epoxy resin; and combinations thereof. Among the commercially available epoxies useful as the epoxy component include polyglycidyl derivatives of phenolic compounds, such as those available from Resolution Performance, under the EPON tradename, such as EPON 1009F [bisphenol A epoxy resin (CAS No. 25036-25-3)], EPON 1001F. EPON 1002F, EPON 1004F, EPON 1007F. EPON 3001, EPON 3002, EPON 2002, EPON 2003, EPON 2004, EPON 2005, EPON 2012, EPON 2014, EPON 2024, and EPON 2042; from Dow Chemical Co. under the DER trade designation, such as DER 331, DER 332, DER 383, DER 354, and DER 542; from Huntsman under the ARALDITE tradename, such as ARALDITE [phenol-4,4′-(1-methylethylidene)bis with (chloromethyl) oxirane (CAS No. 25068-38-6)], ARALDITE ECN 1299 [formaldehyde, polymer with (chloromethyl) oxirane and 2-methylphenol, melting point 85-100° C. (CAS No. 29690-82-2)] and ARALDITE ECN 1285 [formaldehyde, polymer with (chloromethyl) oxirane and 2-methylphenol, melting point 80-90° C. (CAS No. 29690-82-2)], and ARALDITE CT 7097 US [(phenol, 4-(1,1-dimethylethyl), polymer with (chloromethyl) oxirane and 4,4-(1-(1-methylethylidene)bis, melting point 113-123° C. (CAS No. 67924-34-9)]; and from Nippon Kayaku, Japan, BREN-S. Other suitable epoxy resins include polyepoxides prepared from polyols and the like and polyglycidyl derivatives of phenol-formaldehyde novolacs, the latter of which are available commercially from Dow Chemical Company under the tradename DEN, such as DEN 431, DEN 438, and DEN 439.

Polyglycidyl adducts of amines, aminoalcohols and polycarboxylic acids are also useful in this invention, commercially available resins of which include GLYAMINE 135, GLYAMINE 125, and GLYAMINE 115 from BP Chemicals, LTD., ARALDITE MY 720, ARALDITE MY 721, ARALDITE MY 0500, and ARALDITE MY 0510 from Huntsman.

The epoxy component of (b) may be present in an amount of about 0.5 percent by weight to about 10 percent by weight, such as about 1 percent by weight to about 2 percent by weight, based on the total weight of the composition.

### (Meth)acrylate Component

The (meth)acrylate component of (c) used in the inventive conductive die attach composition may be selected from mono-functional (meth)acrylates, di-functional (meth)acrylates or polyfunctional (meth)acrylates, which may be monomeric, oligomeric or polymeric.

Where the (meth)acrylate component of (c) is the mono-functional (meth)acrylate it may be represented by H₂C=CGCO₂R¹, wherein G is selected from H, halogen and alkyl having from 1 to about 4 carbon atoms, and R¹ is selected from alkyl, cycloalkyl, alkenyl, cycloalkenyl, alkaryl, and aryl groups having from 6 to about 16 carbon atoms, with or without substitution or interruption by a member selected from the group consisting of silane, silicon, oxygen, halogen, carbonyl, hydroxyl, ester, carboxylic acid, urea, urethane, carbamate, amine, amide, sulfur, sulfonate and sulfone. A commercially available example of monofunctional (meth)acrylates is SR506A (isobornyl acrylate), from Arkema Inc.

Thus, di-functional (meth)acrylates or polyfunctional (meth)acrylates may have the (meth)acrylate functionality at the terminal ends or pendant along a chain or backbone between the terminus thereof. Commercially available examples of multifunctional (meth)acrylates include SR368 (trifunctional acrylate) and/or SR248 (neopentyl glycol dimethacrylate), each from Arkema Inc.

Specific examples of the (meth)acrylate component of (c) may be selected from silicone (meth)acrylates, polyethylene glycol di(meth)acrylates, tetrahydrofuran (meth)acrylates and di(meth)acrylates, hydroxyethyl (meth)acrylate, hydroxypropyl (meth)acrylate, isobornyl acrylate, hexanediol di(meth)acrylate, trimethylol propane tri(meth)acrylates, diethylene glycol di(meth)acrylates, triethylene glycol di(meth)acrylates, tetraethylene diglycol di(meth)acrylates, diglycerol tetra(meth)acrylates, tetramethylene di(meth)acrylates, ethylene di(meth)acrylates, neopentyl glycol di(meth)acrylates, butane diol di(meth)acrylates, bisphenol-A-(meth)acrylates, ethoxylated bisphenol-A-(meth)acrylates, bisphenol-F-(meth)acrylates, ethoxylated bisphenol-F-(meth)acrylates, bisphenol-A di(meth)acrylates, ethoxylated bisphenol-A-di(meth)acrylates, bisphenol-F-di(meth)acrylates, and ethoxylated bisphenol-F-di(meth)acrylates.

The (meth)acrylate component of (c) should be present in an amount of about 1 percent by weight to about 30 percent by weight, such as about 10 percent by weight to about percent by weight, based on the total weight of the composition.

### Aromatic Anhydride

The aromatic anhydride of (d) used in the inventive conductive die attach composition may be a functionalized trimellitic anhydride, such as 4-methacryloxyethyl trimellitic anhydride (“4-META”), shown below.

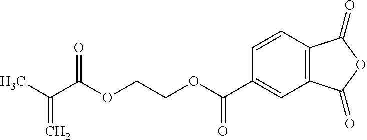 [SMILES: C=C(C)C(=O)OCCOC(=O)c1ccc2c(c1)C(=O)OC2=O]

The aromatic anhydride of (d) should be present in an amount of about 0.1 percent by weight to about 1 percent by weight, such as about 0.2 percent by weight to about 0.8 percent by weight, based on the total weight of the composition.

### Conductive Filler

The conductive filler of (e) used in the inventive conductive die attach composition should be silver powder or silver flake, though additional conductive fillers may be used instead or in addition to such silvers. Included among such additional conductive fillers are copper, gold, alumina, and graphite.

The conductive filler of (e) in some instances may be a combination of silver powder and silver flake.

The conductive filler of (e) should have a particle size in the range of about 10⁻⁷ to about 10⁻⁶. For instance, the conductive filler of (e) may be silver powder having a particle size of about 10⁻⁶ or silver flake having a particle size of about 10⁻⁷.

The conductive filler of (e) should be present in an amount of about 10 percent by weight to about 90 percent by weight, such as about 60 percent by weight to about 80 percent by weight, based on the total weight of the composition.

### Curatives

In some embodiments it may be desirable to include curatives in the inventive conductive die attach composition.

Suitable curatives include heat cure catalysts to reduce the temperature at which cure occurs or hasten the degree of cure when the appropriate temperature condition is selected for cure to occur.

The heat cure catalyst may be chosen from free radical catalysts, anionic curatives, cationic curatives, and combinations thereof.

For instance, the free radical catalyst may be chosen from peroxides, azo compounds, and combinations thereof. Particularly desirable peroxide catalysts include dicumyl peroxide, dibenzoyl peroxide, 2-butanone peroxide, tert-butyl perbenzoate, di-tert-butyl peroxide, 2,5-bis(tert-butylperoxy)-2,5-dimethylhexane, bis(tert-butyl peroxyisopropyl)benzene, and tert-butyl hydroperoxide, and azo compounds include 2,2′-azobis(2-methylpropanenitrile), 2,2′-azobis(2-methylbutanenitrile), and 1,1′-azobis(cyclohexanecarbonitrile).

Commercially available examples of these free radical catalysts include those promoted by Akzo Nobel, such as the following peroxides dl-isobutyryl peroxide (CAS No. 3437-84-1-), cumyl peroxyneodecanoate (CAS No. 26748-47-0), peroxydicarbonate mixture (CAS No. 105-64-6; 19910-65-7; 78350-78-4), 2,4,2-trimethylypentyl-2 peroxyneodecanoate (CAS No. 51240-95-0), cumyl peroxyneoheptanoate (CAS No. 68299-16-1), di-sec-butyl peroxydicarbonate (CAS No. 19910-65-7), tert-butylperoxyneodecanoate (CAS No. 26748-41-4), dibutyl peroxydicarbonate (CAS No. 16215-49-9), dicetyl peroxydicarbonate (CAS No. 26332-14-5), di(4-tert-butylcyclohexyl) peroxydicarbonate (CAS No. 15520,-11-3), di(2-ethylhexyl) peroxydicarbonate (CAS No. 16111-62-9), dimyristyl peroxydicarbonate (CAS No. 53220-22-7), tert-butyl peroxyneoheptanoate (CAS No. 26748-38-9), tert-amyl peroxypivalate (CAS No. 29240-17-3), tert-butyl peroxypivalate (CAS No. 927-07-1), di-(3,5,5-trimethylhexanoyl) peroxide (CAS No. 3851-87-4), dilauroyl peroxide (CAS No. 105-74-8), dioctanoyl peroxide (CAS No. 762-16-3), didecanoyl peroxide (CAS No. 762-12-9), 2,5-dimethyl-2,5-di(2-ethylhexanoylperoxy) hexane (CAS No. 13052-09-0), tert-amyl peroxy-2-ethylhexanoate (CAS No. 686-31-7), tert-butyl peroxy-2-ethylhexanoate (CAS No. 3006-82-4), dibenzoyl peroxide (CAS No. 94-36-0), 1,1-di(tert-butylperoxy)-3,3,5-trimethylcyclohexane (CAS No. 6731-36-8), 2,2-bis[4,4-di-(tertbutyl-peroxy-cyclohexylpropane] (CAS No. 1705-60-8), 1,1-di(tert-amylperoxy)cyclohexane (CAS No. 15667-10-4), 1,1-di(tert-butylperoxy)cyclohexane (CAS No. 3006-86-8), tert-amyl peroxy 2-ethylhexyl carbonate (CAS No. 70833-40-8), tert-butyl peroxy-3,5,5-trimethylhexanoate (CAS No. 13122-18-4), tert-butyl peroxy-2-methylbenzoate (CAS No. 22313-62-8), 2,2-di-(tert-butylperoxy) butane (CAS No. 2167-23-9), tert-butyl peroxy isopropyl carbonate (CAS No. 2372-21-6), tert-butyl peroxy 2-ethylhexyl carbonate (CAS No. 34443-12-4), tert-amyl peroxybenzoate (CAS No. 4511-39-1), tert-butyl peroxyacetate (CAS No. 107-71-1), butyl 4,4-di-(tert-butylperoxy) valerate (CAS No. 995-33-5), tert-butyl peroxybenzoate (GAS No. 614-45-9), di-tert-amyl peroxide (GAS No. 10508-09-5), dicumyl peroxide (GAS No. 80-43-3), di-(tert-butylperoxyisopropyl)benzene (CAS No. 25155-25-3), 2,5-dimethyl-2,5-di(tert-butylperoxy) hexane (CAS No. 78-63-7), tert-butyl cumyl peroxide (CAS No. 3457-61-2), 2,5-dimethyl-2,5-di(tertbutylperoxy) hexyne-3 (CAS No. 1068 Feb. 7-5), di-tert-butyl peroxide (CAS No. 110-05-4), 3,6,9-triethyl-3,6,9-trimethyl-1,4,7-triperoxonane (CAS No. 24748-23-0) 1,1,3,3-tetramethylbutyl hydroperoxide (CAS No. 5809-08-5), diisopropylbenzene monohydroperoxide (CAS No. 26762-93-6), cumyl hydroperoxide (CAS No. 80-15-9), tert-butyl hydroperoxide (CAS No. 75-91-2), and tert-amyl hydroperoxide (CAS No. 3425-61-4), and the following azo compounds 2,2′-azobis(isobutyronitrile) (CAS No. 78-671), 2,2′-azobis(2-methylbutyronitrile) (CAS No. 13472-08-7), and 1,1′azobis(1-cyclohexanenitrile) (CAS No. 2094-98-6).

The heat cure catalyst may also be an anionic curative, such as those broadly described as aza compounds, amine compounds, amide compounds, imidazole compounds, and combinations thereof. More specific examples of aza compounds include

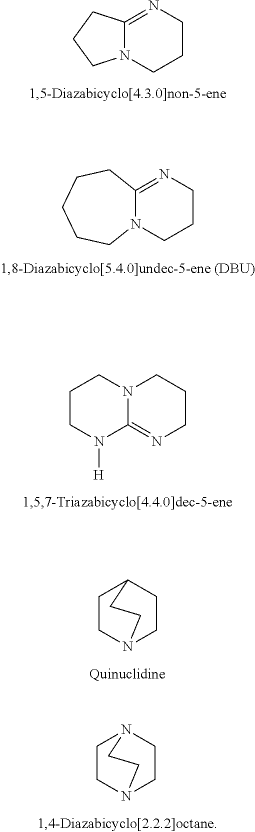 [SMILES: C1CN=C2CCCN2C1 ; C1CCC2=NCCCN2CC1 ; C1CN=C2NCCCN2C1 ; C1CN2CCC1CC2 ; C1CN2CCN1CC2]

More specific examples of amine compounds include aliphatic polyamines, aromatic polyamines, alicyclic polyamines, such as diethylenetriamine, triethylenetetraamine, diethylaminopropylamine, benzyl dimethylamine, m-xylenediamine, diaminodiphenylamine, quinoxaline, isophoronediamine, menthenediamine and combinations.

A more specific example of an amide compound is the functionalized amide, dicyandiamide.

More specific examples of imidazole compounds include isoimidazole, imidazole, 2-ethyl-4-methylimidazole, 2,4-dimethylimidazole, butylimidazole, 2-heptadeceny-4-methylimidazole, 2-methylimidazole, 2-undecenylimidazole, 1-vinyl-2-methylimidazole, 2-undecylimidazole, 2-heptadecylimidazole, 2-phenylimidazole, 1-benzyl-2-methylimidazole, 1-propyl-2-methylimidazole, 1-cyanoethyl-2-methylimidazole, 1-cyanoethyl-2-ethyl-4-methylimidazole, 1-cyanoethyl-2-undecylimidazole, 1-cyanoethyl-2-phenylimidazole, 1-guanaminoethyl-2-methylimidazole, addition products of an imidazole and methylimidazole, addition products of an imidazole and trimellitic acid, 2-n-heptadecyl-4-methylimidazole, phenylimidazole, benzylimidazole, 2-methyl-4,5-diphenylimidazole, 2,3,5-triphenylimidazole, 2-styrylimidazole, 1-(dodecyl benzyl)-2-methylimidazole, 2-(2-hydroxyl-4-t-butylphenyl)-4,5-diphenylimidazole, 2-(2-methoxyphenyl)-4,5-diphenylimidazole, 2-(3-hydroxyphenyl)-4,5-diphenylimidazole, 2-(p-dimethylaminophenyl)-4,5-diphenylimidazole, 2-(2-hydroxyphenyl)-4,5-diphenylimidazole, di(4,5-diphenyl-2-imidazole)-benzene-1,4,2-naphthyl-4,5-diphenylimidazole, 1-benzyl-2-methylimidazole, 2-p-methoxystyrylimidazole, and combinations thereof.

### Optional Additives

In some embodiments it may be desirable to include other additives in the inventive conductive die attach composition. Examples of such additives include adhesion promoters, like silanes, acids, and anhydrides.

In a desirable embodiment, the conductive die attach composition comprises:
A resin comprising those containing one or more maleimide, itaconimide or nadimide functional groups or combinations of said functional groups, wherein the resin contains one or more maleimide functional groups;
An epoxy component, wherein the epoxy component is selected from biphenyl epoxy resin, bisphenol A, E, S or F epoxy resin, such as bisphenol A epoxy resin;
A (meth)acrylate component, wherein the (meth)acrylate component is a mixture of a multifunctional acrylate [such as SR368 (trifunctional acrylate) and/or SR248 (neopentyl glycol dimethacrylate), each from Arkema Inc.], and monofunctional (meth)acrylates [such as SR506A (isobornyl acrylate), from Arkema Inc];
An aromatic anhydride, wherein the aromatic anhydride is 4-methacryloxyethyl trimellitic anhydride; and
A conductive filler, wherein the conductive filler is silver.

In an alternative desirable embodiment, the conductive die attach composition comprises:
A resin comprising those containing one or more maleimide, itaconimide or nadimide functional groups or combinations of said functional groups, wherein the resin contains one or more maleimide functional groups and is present in an amount in the range of about 1 percent by weight to about 10 percent by weight, based on the total weight of the composition;
An epoxy component, wherein the epoxy component is bisphenol A epoxy resin and is present in an amount in the range of about 1 percent by weight to about 5 percent by weight, based on the total weight of the composition;
A (meth)acrylate component, wherein the (meth)acrylate component is a mixture of a multifunctional acrylate [such as SR368 (trifunctional acrylate) and/or SR248 (neopentyl glycol dimethacrylate), each from Arkema Inc.], and a monofunctional acrylate [such as SR506A (isobornyl acrylate), from Arkema Inc.], and combinations thereof and is present in an amount in the range of between about 1 percent by weight to about 10 percent by weight, based on the total weight of the composition;
An aromatic anhydride, wherein the aromatic anhydride is 4-methacryloxyethyl trimellitic anhydride and is present in an amount in the range of between about 0.1 percent by weight to about 1 percent by weight, based on the total weight of the composition; and
A conductive filler, wherein the conductive filler is silver and is present in an amount in the range of between about 10 percent by weight to about 90 percent by weight, based on the total weight of the composition.

When cured through exposure to elevated temperature conditions the composition exhibits after exposure to further elevated temperature conditions of about 121° C. and elevated humidity conditions of about 100% for a period of time of about 16 hours, a die shear strength on copper lead frame of greater than about 200 percent by weight when compared with a comparable composition without the aromatic anhydride.

Provided herein are also methods of preparing such inventive conductive die attach compositions, methods of using such inventive conductive die attach compositions, methods of improving adhesion of conductive die attach compositions to metal leadframe, and the so formed semiconductor device using the inventive conductive die attach compositions.

That is, the inventive die attach compositions may be prepared by mixing together the recited constituents and blending the constituents to form a conductive die attach composition.

The inventive die attach compositions may also be dispensed onto a substrate, such as a circuit board or a carrier substrate, and thereafter a semiconductor chip or package may be disposed over the dispensed die attach composition, and then exposed to conditions favorable to form an adhesive bond therebetween.

The inventive die attach compositions may also be used to improve adhesion of conductive die attach compositions to metal leadframe, such as copper or nickel. While the formulated inventive conductive die attach composition provides the observed improvement, the inclusion of the aromatic anhydride is believed to impart the benefit.

### EXAMPLES

### Example 1

Two resin systems were formulated, one with and one without methacryloxyethyl trimellitic anhydride (“4-META”). Each formulation was prepared using the same components. That is, each included the constituents listed below in Table 1, except one of them has 0.25% of 4-META by weight.

TABLE 1

| | | Invention A | Comparative B |
|---|---|---|---|
| Component | Material | % by weight | % by weight |
| Resin 1 | Bismaleimide | 1.49 | 1.50 |
| Resin 2 | Epoxy | 1.00 | 1.01 |
| Resin 3 | Polybutadiene | 7.05 | 7.12 |
| | acrylate | | |
| Diluent | Methacrylate | 11.68 | 11.80 |
| Filler 1 | Silver | 75.00 | 75.00 |
| Filler 2 | Silica | 1.78 | 1.80 |
| Curing agent 1 | Amine | 0.11 | 0.11 |
| Curing agent 2 | Peroxide | 0.12 | 0.12 |
| Inhibitor | Phenol | 0.02 | 0.02 |
| Additive 1 | Fluorinated ester | 0.08 | 0.08 |
| Additive 2 | Mineral oil | 0.01 | 0.01 |
| Adhesion promoter 1 | Silane | 1.41 | 1.43 |
| Adhesion promoter 2 | 4-META | 0.25 | 0 |

These formulations were each used as die attach pastes for dispensing onto 3×3 mm bare silicon die having copper leadframe. Adhesion was measured by die shear strength (“DSS”) with Dage die shear equipment series 4000 at room temperature and 260° C. Six replicates were assembled using these two formulations were cured at a 30-minute ramp time at 5° C. per minute to an ultimate temperature of 175° C., and then held at that temperature for a period of time about 30 minutes in a nitrogen oven.

The post cured parts were then heated on a hot plate set to a temperature of 240° C. for a period of time of about 1 minute, and then baked in the oven for a further 4 hours at 175° C. These conditions are intended to simulate the wire bonding and molding process. Post cured and post mold samples were then sealed in a Parr Bomb chamber with distilled water and heated to a temperature of about 121° C. and maintained there for a period of time of about 16 hours.

Die shear testing was then performed on the so-exposed parts. Results tabulated in Table 2 below show that the formulation with 0.25% of 4-META demonstrated higher (by about 10-30%) die shear strengths from the post cured and post mold parts, and significant stronger (by about 200%-300%) die shear strengths after Parr Bomb conditioning for both post cured and post mold cured parts.

TABLE 2

| | Inven- | Compar- |
|---|---|---|
| 3 × 3 mm Si to Cu | tion A | ative B |
| DSS @ RT (kg) | 22.61 | 19.99 |
| (30 min ramp to 175° C. for 30 min in N₂) | | |
| DSS @ 260° C. (kg) | 3.66 | 2.73 |
| (30 min ramp to 175° C. for 30 min in N₂) | | |
| DSS @ RT (kg) | 27.07 | 22.87 |
| (30 min ramp to 175° C. for 30 min in N₂ + | | |
| 1 min @ 240° C. + 4 hours @ 175° C.) | | |
| DSS @ 260 C. (kg) | 6.35 | 5.23 |
| (30 min ramp to 175° C. for 30 min in N₂ + | | |
| 1 min @ 240° C. + 4 hours@175° C.) | | |
| DSS @ RT (kg) | 11.93 | 4.60 |
| (30 min ramp to 175° C. for 30 min in N₂ + | | |
| 16 hours @ 121° C. (100% humidity)) | | |
| DSS @ 260 C. (kg) | 2.17 | 1.56 |
| (30 min ramp to 175° C. for 30 min in N₂ + | | |
| 16 hours @ 121° C. (100% humidity)) | | |
| DSS @ RT (kg) | 12.70 | 5.25 |
| (30 min ramp to 175° C. for 30 min in N₂ + | | |
| 1 min @ 240° C. + 4 hours @ 175° C. + 16 | | |
| hours @ 121° C. (100% humidity)) | | |
| DSS @ 260° C. (kg) | 2.90 | 1.26 |
| (30 min ramp to 175° C. for 30 min in N₂ + | | |
| 1 min @ 240° C. + 4 hours @ 175° C. + 16 | | |
| hours @ 121° C. (100% humidity)) | | |

Thus, the inclusion of 4-META improved adhesion of the die attach paste on copper leadframe and maintained strong die shear after high temperature and high moisture exposure.

### Example 2

Here, two die attach paste formulations were prepared, one without 4-META and one with 4-META. Each formulation was prepared using the same components. That is, each included the constituents listed below in Table 3, except one of them has 4-META included in an amount of about 0.46 percent by weight. Here these formulations were used on nickel leadframe.

TABLE 3

| | | Invention C | Comparative D |
|---|---|---|---|
| Component | Material | % by weight | % by weight |
| Resin 1 | Bismaleimide | 6.11 | 6.42 |
| Resin 2 | Epoxy | 1.23 | 1.26 |
| Resin 3 | Polybutadiene | 1.44 | 1.51 |
| Diluent | (Meth)acrylate | 7.39 | 7.35 |
| Filler 1 | Silver | 82.20 | 82.20 |
| Curing agent 1 | Peroxide | 0.29 | 0.3 |
| Curing agent 2 | Peroxide | 0.47 | 0.50 |
| Additive | Fluorinated | 0.08 | 0.09 |
| | ether Acid | 0.14 | 0.15 |
| Adhesion | Silane | 0.20 | 0.21 |
| promoter 1 | | | |
| Adhesion | 4-META | 0.46 | 0 |
| promoter 2 | | | |

The formulations were each disposed on 3×3 mm stainless steel die, attached on nickel leadframe. The so-formed assemblies were cured on a hot plate set at a temperature of 150° C. for a period of time of about 1 minute, then baked in an oven with a 30 minute ramp to a temperature of 175° C., and subsequently held for 30 minutes in air.

Die shear strength was again measured with Dage die shear equipment series 4000 at room temperature and 260° C. From 0% to 0.46% of 4-META formulations, the die shear strength for the samples increased by 50% and the die shear strength for post cured samples increased by 40%. From 0% to 0.85 percent by weight of 4-META, the die shear strength for the samples increased by 10% and the die shear strength for post cured samples increased by 20%.

TABLE 4

| 3 × 3 mm Si to Ni | Invention C | Comparative D |
|---|---|---|
| DSS @ RT (kg) | 34.08 | 27.09 |
| (1 min @ 175° C. hot plate) | | |
| DSS @ RT (kg) | 31.86 | 27.6 |
| (1 min @ 175° C. + 30 min ramp | | |
| to 175° C. for 1 hour in air) | | |
| DSS @ 260° C. (kg) | 4.70 | 4.19 |
| (1 min @ 175° C. + 30 min ramp | | |
| to 175° C. for 1 hour in air) | | |

Thus, the inclusion of 4-META improved adhesion of the die attach paste on nickel leadframe and maintained strong die shear after high temperature exposure.

What is claimed is:

1. A conductive die attach composition comprising:
(a) A resin comprising those containing one or more maleimide, itaconimide or nadimide functional groups or combinations of said functional groups;
(b) An epoxy component;
(c) A (meth)acrylate component;
(d) An aromatic anhydride; and
(e) A conductive filler.

2. The composition of claim 1, wherein when cured through exposure to elevated temperature conditions the composition exhibits after exposure to further elevated temperature conditions of about 121° C. and elevated humidity conditions of about 100% for a period of time of about 16 hours, a die shear strength on copper lead frame of greater than about 200 percent by weight when compared with a comparable composition without the aromatic anhydride.

3. The composition of claim 1, wherein the resin of (a) is a member selected from the group consisting of 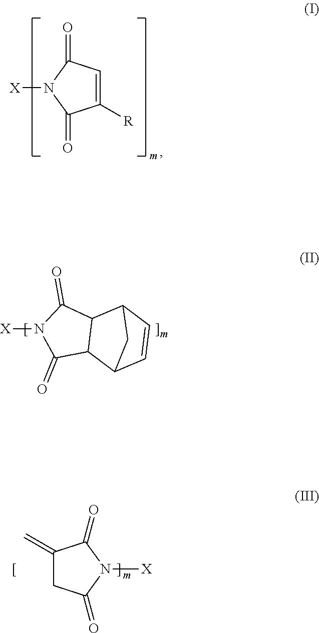
wherein
m=1-15,
R is independently selected from hydrogen or alkyl having from 1 to about 4 carbon atoms, and
X is a monovalent moiety or a multivalent linking moiety comprising organic or organosiloxane radicals.

4. The composition of claim 1, wherein the resin of (a) is phenylenedimaleimide.

5. The composition of claim 1, wherein the resin of (a) is present in an amount of about 1 percent by weight to about 10 percent by weight.

6. The composition of claim 1, wherein the epoxy component of (b) is a member selected from the group consisting of an aromatic epoxy resin, an aliphatic epoxy resin and a cycloaliphatic epoxy resin.

7. The composition of claim 1, wherein the epoxy component of (b) is a member selected from the group consisting of biphenyl epoxy resin, bisphenol A, E, S or F epoxy resin.

8. The composition of claim 1, wherein the epoxy component of (b) is present in an amount of about 0.5 percent by weight to about 10 percent by weight.

9. The composition of claim 1, wherein the (meth)acrylate component of (c) is represented by H₂C=CGCO₂R¹, wherein G is a member selected from the group consisting of H, halogen and alkyl having from 1 to about 4 carbon atoms, and R¹ is a member selected from the group consisting of alkyl, cycloalkyl, aklenyl, cycloalkenyl, alkaryl, and aryl groups having from 6 to about 16 carbon atoms, with or without substitution or interruption by a member selected from the group consisting of silane, silicon, oxygen, halogen, carbonyl, hydroxyl, ester, carboxylic acid, urea, urethane, carbamate, amine, amide, sulfur, sulonate and sulfone.

10. The composition of claim 1, wherein the (meth)acrylate component is a member selected from the group consisting of silicone (meth)acrylates, polyethylene glycol di(meth)acrylates, tetrahydrofuran (meth)acrylates and di(meth)acrylates, hydroxyethyl (meth)acrylate, hydroxypropyl (meth)acrylate, isobornyl acrylate, hexanediol di(meth)acrylate, trimethylol propane tri(meth)acrylates, diethylene glycol di(meth)acrylates, triethylene glycol di(meth)acrylates, tetraethylene diglycol di(meth)acrylates, diglycerol tetra(meth)acrylates, tetramethylene di(meth)acrylates, ethylene di(meth)acrylates, neopentyl glycol di(meth)acrylates, butane diol di(meth)acrylates, bisphenol-A-(meth)acrylates, ethoxylated bisphenol-A-(meth)acrylates, bisphenol-F-(meth)acrylates, ethoxylated bisphenol-F-(meth)acrylates, bisphenol-A di(meth)acrylates, ethoxylated bisphenol-A-di(meth)acrylates, bisphenol-F-di(meth)acrylates, and ethoxylated bisphenol-F-di(meth)acrylates.

11. The composition of claim 1, wherein the (meth)acrylate component of (c) is a member selected from the group consisting of multifunctional (meth)acrylates and monofunctional (meth)acrylates acrylate and combinations thereof.

12. The composition of claim 1, wherein the (meth)acrylate component of (c) is present in an amount of about 1 percent by weight to about 10 percent by weight.

13. The composition of claim 1, wherein the aromatic anhydride of (d) is a functionalized trimellitic anhydride.

14. The composition of claim 1, wherein the aromatic anhydride of (d) is 4-methacryloxyethyl trimellitic anhydride.

15. The composition of claim 1, wherein the aromatic anhydride of (d) is present in an amount of about 0.1 percent by weight to about 1 percent by weight.

16. The composition of claim 1, wherein the conductive filler of (e) is silver powder or silver flake.

17. The composition of claim 1, wherein the conductive filler of (e) is a combination of silver powder and silver flake.

18. The composition of claim 1, wherein the conductive filler of (e) has a particle size in the range of about 10⁻⁷ to about 10⁻⁶.

19. The composition of claim 1, wherein the conductive filler of (e) is silver powder having a particle size of about 10-6 or silver flake having a particle size of about 10-7.

20. The composition of claim 1, wherein the conductive filler of (e) is present in an amount of about 10 percent by weight to about 90 percent by weight.

21. A conductive die attach composition comprising:
(a) A resin comprising those containing one or more maleimide, itaconimide or nadimide functional groups or combinations of said functional groups, wherein the resin contains one or more maleimide functional groups;
(b) An epoxy component, wherein the epoxy component is a member selected from the group consisting of biphenyl epoxy resin, bisphenol A, E, S or F epoxy resin;
(c) A (meth)acrylate component, wherein the (meth)acrylate component is a mixture of multifunctional (meth)acrylate and monofunctional (meth)acrylate, and combinations thereof;
(d) An aromatic anhydride, wherein the aromatic anhydride is 4-methacryloxyethyl trimellitic anhydride; and
(e) A conductive filler, wherein the conductive filler is silver.

22. A conductive die attach composition comprising:
(a) A resin comprising those containing one or more maleimide, itaconimide or nadimide functional groups or combinations of said functional groups, wherein the resin contains one or more maleimide functional groups and is present in an amount in the range of between about 1 percent by weight to about 10 percent by weight;
(b) An epoxy component, wherein the epoxy component is bisphenol A epoxy resin and is present in an amount in the range of between about 1 percent by weight to about 5 percent by weight;
(c) A (meth)acrylate component, wherein the (meth)acrylate component is a mixture of multifunctional (meth)acrylate and monofunctional (meth)acrylate, and combinations thereof and is present in an amount in the range of between about 1 percent by weight to about 10 percent by weight;
(d) An aromatic anhydride, wherein the aromatic anhydride is 4-methacryloxyethyl trimellitic anhydride and is present in an amount in the range of between about 0.1 percent by weight to about 1 percent by weight; and
(e) A conductive filler, wherein the conductive filler is silver and is present in an amount in the range of between about 10 percent by weight to about 90 percent by weight.
